(19) United States
(12) Patent Application Publication
(10) Pub. No.: US 2026/0156199 A1
(43) Pub. Date: Jun. 4, 2026

(54) NETWORK-BASED COLLECTION OF USER ACTIVITY DATA FOR PERSONAL ARTIFICIAL INTELLIGENCE

(71) Applicant: AT&T Intellectual Property I, L.P., Atlanta, GA (US)

(72) Inventors: Gregory W. Edwards, Austin, TX (US); James H. Pratt, Round Rock, TX (US); Robert Moton, JR., Alpharetta, GA (US); Eric Zavesky, Austin, TX (US); Adrianne Binh Luu, Atlanta, GA (US); Ari Craine, Marietta, GA (US); Robert Koch, Norcross, GA (US)

(73) Assignee: AT&T Intellectual Property I, L.P., Atlanta, GA (US)

(21) Appl. No.: 18/964,793

(22) Filed: Dec. 2, 2024

(51) Int. Cl. H04L 67/50; H04L 67/306

(52) U.S. Cl. CPC H04L 67/535; H04L 67/306

(57) ABSTRACT

Aspects of the subject disclosure may include, for example, a device that collects user content data, both explicitly generated and implicitly generated, tags it with a user ID, and stores it in a database. The data is retrieved upon request and sent to a machine learning application to generate user-specific artificial intelligence (AI). The AI data is accessible via a personal recall application for user or authorized third-party queries. Other embodiments are disclosed.

### FIELD OF THE DISCLOSURE

The subject disclosure relates to Artificial Intelligence (AI) systems.

### BACKGROUND

Existing systems lack a method to capture and utilize a user's knowledge, as demonstrated by their actions and activities, for the purpose of enabling an application to assist the user or another party in recalling this knowledge. This deficiency is particularly significant for users who may become forgetful or have impaired memory, as well as for caregivers or assistants who could benefit from understanding the user's historical knowledge to provide better assistance.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a sensor 200 functioning within the communications network 125 of FIG. 1 in accordance with various aspects described herein.

FIG. 2B is a block diagram illustrating an example, non-limiting embodiment of a user activity monitor server in communication with a user and external sensor in accordance with various aspects described herein.

FIG. 2C is a block diagram illustrating an example, non-limiting embodiment of a system generating explicitly generated content in accordance with various aspects described herein.

FIG. 2D is a block diagram illustrating an example, non-limiting embodiment of system using a user activity monitor application in accordance with various aspects described herein.

FIG. 2E is a block diagram illustrating an example, non-limiting embodiment of a system generating implicitly generated content in accordance with various aspects described herein.

FIG. 2F is a block diagram illustrating an example, non-limiting embodiment of a system collecting content data for use in machine learning in accordance with various aspects described herein.

FIG. 2G is a block diagram illustrating an example, non-limiting embodiment of a system generating personal AI data in accordance with various aspects described herein.

FIG. 2H is a block diagram illustrating an example, non-limiting embodiment of a user performing a query of personal AI data using a personal recall application in accordance with various aspects described herein.

FIG. 2I is a block diagram illustrating an example, non-limiting embodiment of a third party performing a query of personal AI data using a personal recall application in accordance with various aspects described herein.

FIG. 2J depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for network-based collection of user activity data for personal artificial intelligence. Other embodiments are described in the subject disclosure.

Various embodiments described herein present a system and method for creating a personal artificial intelligence (AI) based on a user's past activities. The system captures and utilize a user's knowledge, as demonstrated by their actions and activities, to assist the user or another party in recalling this information. This is particularly useful for users who may become forgetful or have impaired memory, as well as for caregivers or assistants who could benefit from understanding the user's historical knowledge to provide better assistance.

Various embodiments include a user device equipped with onboard sensors, such as cameras and microphones, and content generation applications. These sensors and applications collect both explicitly generated content, which the user creates, and implicitly generated content, which is gathered by monitoring the user's activities. The user device communicates with a user activity monitor server, which collects the content data, tags it with a user identifier, and stores it in a user-generated content database. The server can also communicate with external sensors to gather additional implicitly generated content.

The collected content data is processed by a machine learning application to generate user-specific AI data. This AI data represents the user's knowledge, experiences, capabilities, and expertise. The AI data is stored in a user profile database and can be accessed through a personal recall application. This application allows the user or an authorized third party to query and utilize the AI data for various purposes, such as recalling how a task was performed in the past or assisting in caregiving.

Various embodiments also include features for user-controlled monitoring preferences, allowing the user to specify what activities can be monitored and when. Temporal settings can be applied to specify monitoring periods, and retroactive monitoring requests can be made to collect past activities that were stored locally. In some embodiments, the user preferences are stored in a user profiles database.

The various embodiments described herein provide a comprehensive method for generating personalized AI by leveraging both explicitly generated content and implicitly generated content, enabling enhanced recall and assistance based on the user's historical activities.

One or more aspects of the subject disclosure include a device having a processing system with a processor and a memory that stores instructions. When these instructions are executed, they enable the device to perform several operations. The device collects content data associated with a user. This content data may include both explicitly generated content, which the user creates, and implicitly generated content, which is gathered by monitoring the user's activities through sensors. The device then associates a user ID tag with the content data and stores it in a content database. When a request for the content data associated with the user ID tag is received, the device retrieves the content data and sends it to a machine learning application. This application generates artificial intelligence data specific to the user based on the content data.

The device may also perform operations for receiving a request from a personal recall application to use the artificial intelligence data specific to the user. This request can come from a personal recall application controlled by the user or by a third party. The device provides access to the artificial intelligence data through the personal recall application, allowing the user or an authorized third party to query and use the artificial intelligence data.

In some embodiments, the implicitly generated content is gathered by monitoring the user's activities through sensors on the user's device, such as a camera and a microphone, as well as through external sensors. The explicitly generated content may be created by the user through various content generation applications.

The device can receive user preferences for monitoring activities and store these preferences in a user profiles database. These preferences can include temporal settings that specify when the user's activities can be monitored.

One or more aspects of the subject disclosure include a non-transitory machine-readable medium having instructions that, when executed by a processing system with a processor, enable the system to perform operations. The operations may include collecting content data associated with a user, tagging it with a user ID, storing it in a content database, retrieving it upon request, and sending it to a machine learning application to generate user-specific artificial intelligence data. The content data can be explicitly generated by the user or implicitly generated through sensors. The system can also receive user preferences for monitoring activities and store these preferences in a user profiles database. The artificial intelligence data can be accessed through a personal recall application, allowing the user or an authorized third party to query and use the data.

One or more aspects of the subject disclosure include a method involving collecting content data associated with a user, tagging it with a user ID, storing it in a content database, retrieving it upon request, and sending it to a machine learning application to generate user-specific artificial intelligence data. The method may also include receiving a request from a personal recall application to use the artificial intelligence data specific to the user. This request can come from a personal recall application controlled by the user or by a third party.

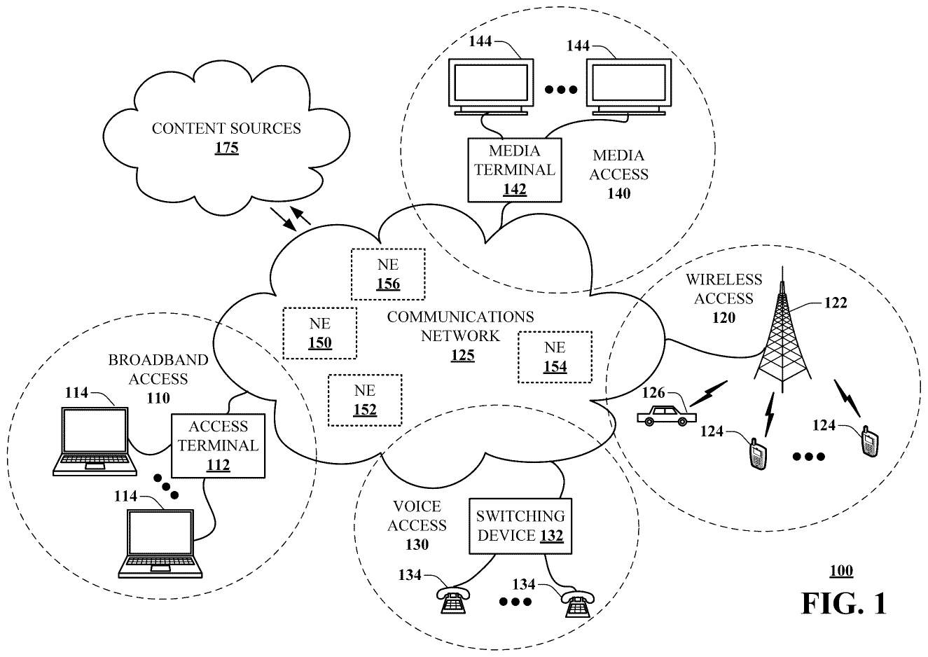

Referring now to FIG. 1, a block diagram is shown illustrating an example, non-limiting embodiment of a system 100 in accordance with various aspects described herein. For example, system 100 can facilitate in whole or in part network-based collection of user activity data for personal artificial intelligence. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

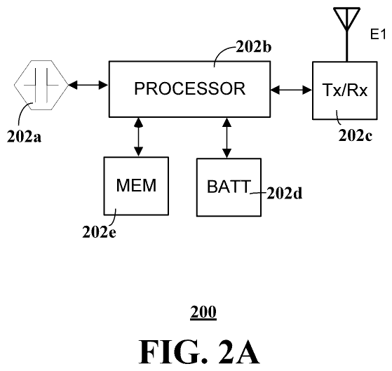

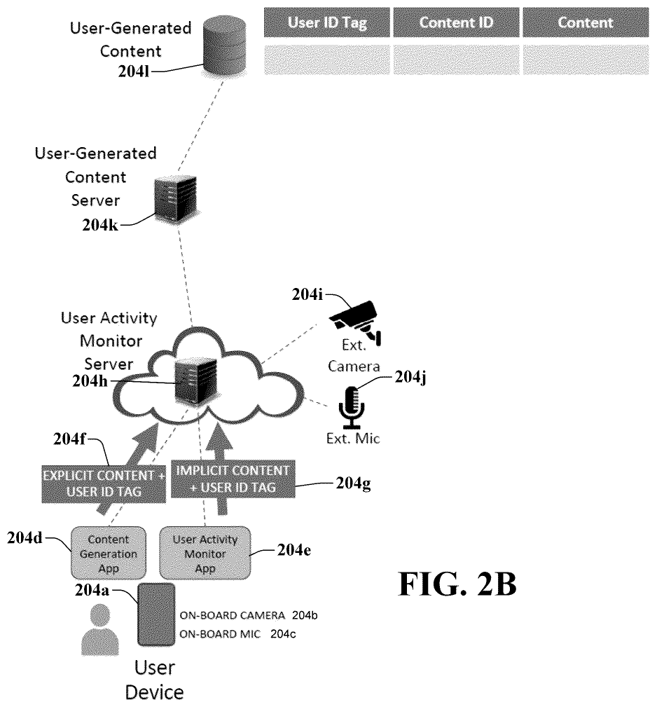

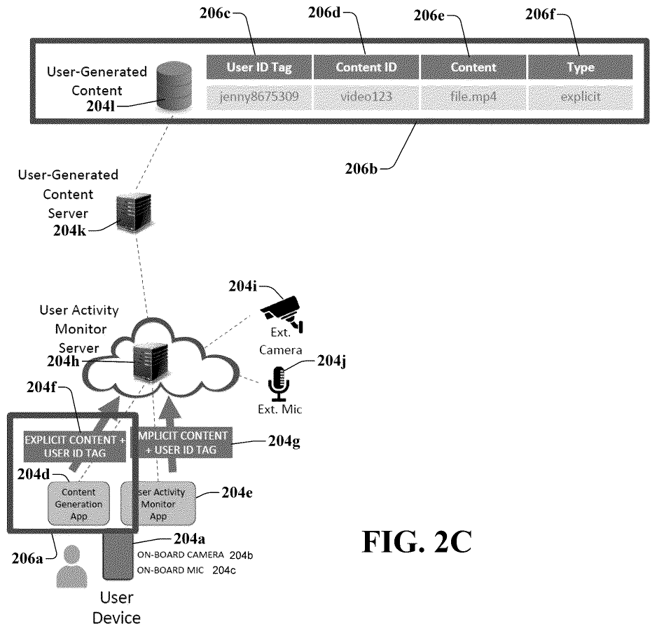

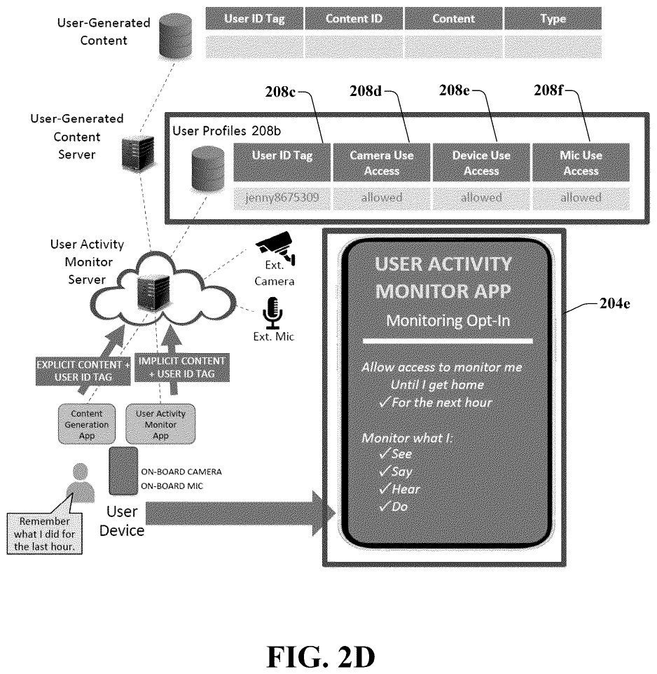

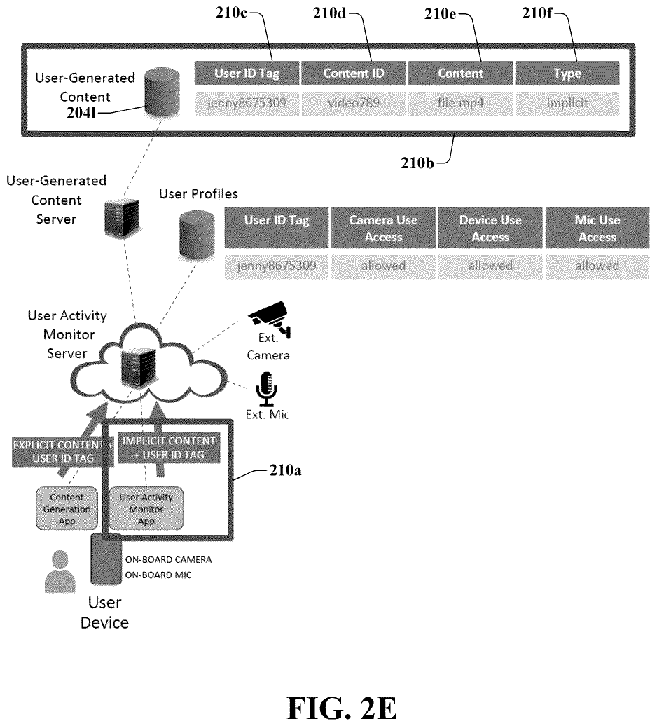

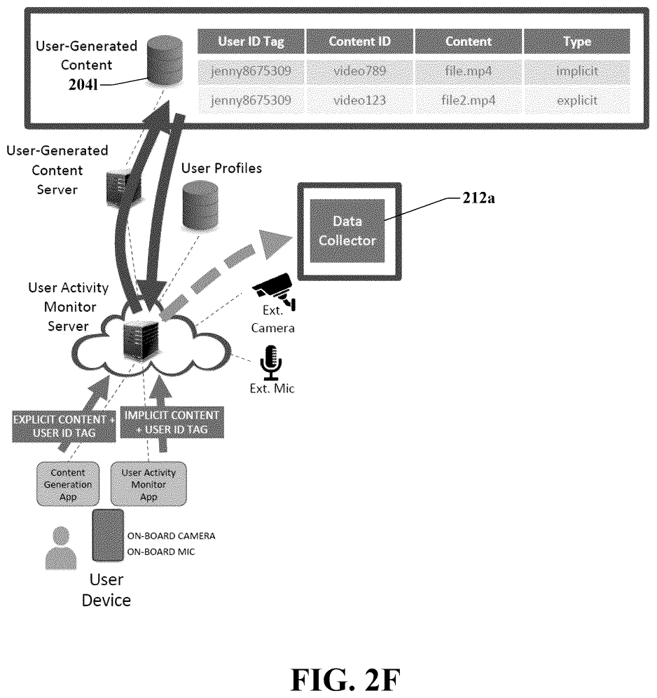

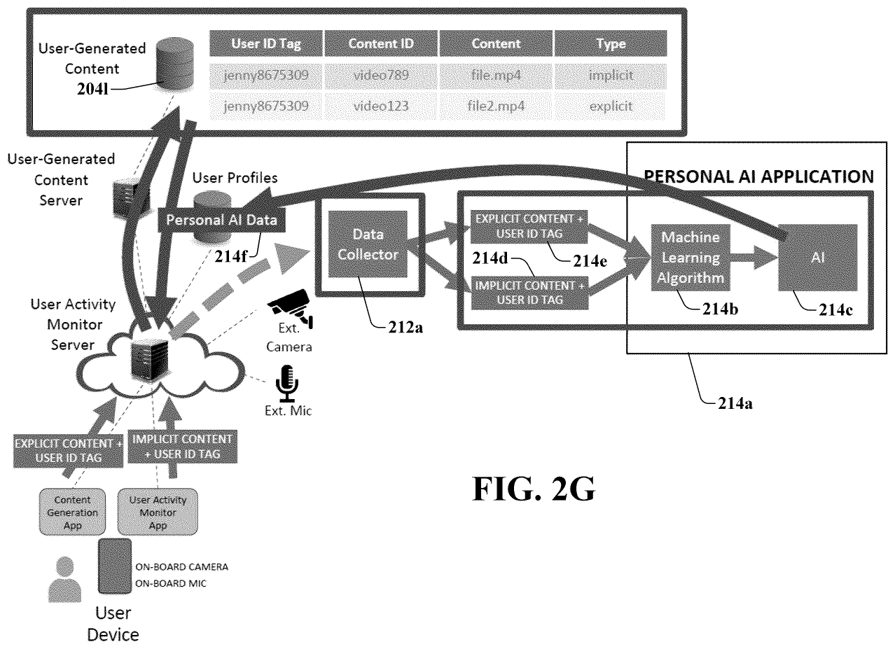

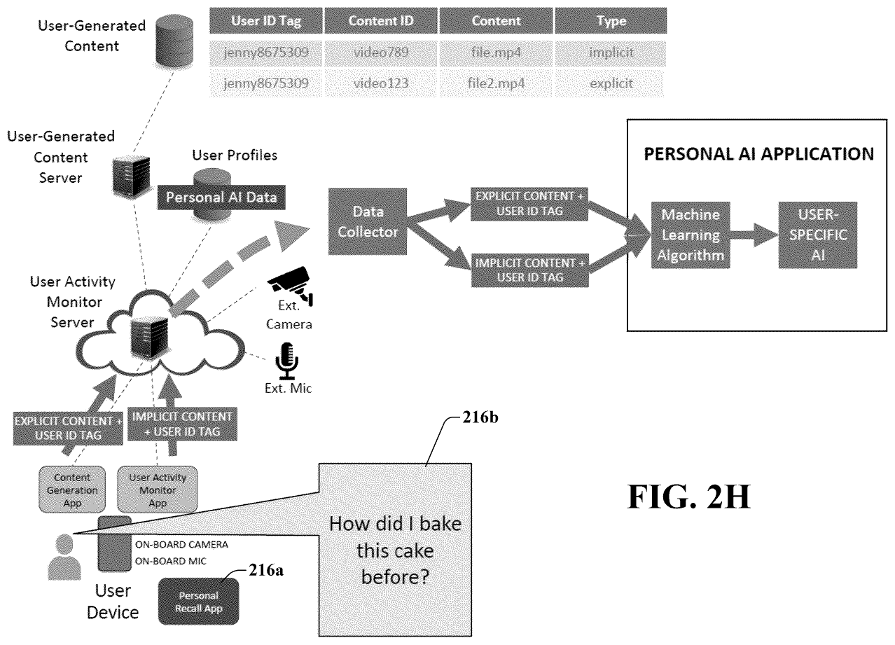

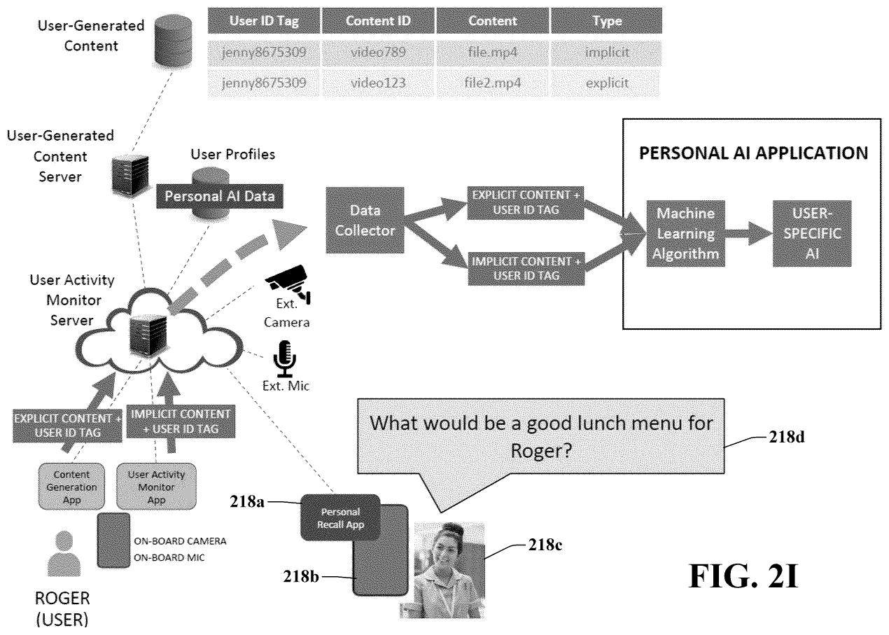

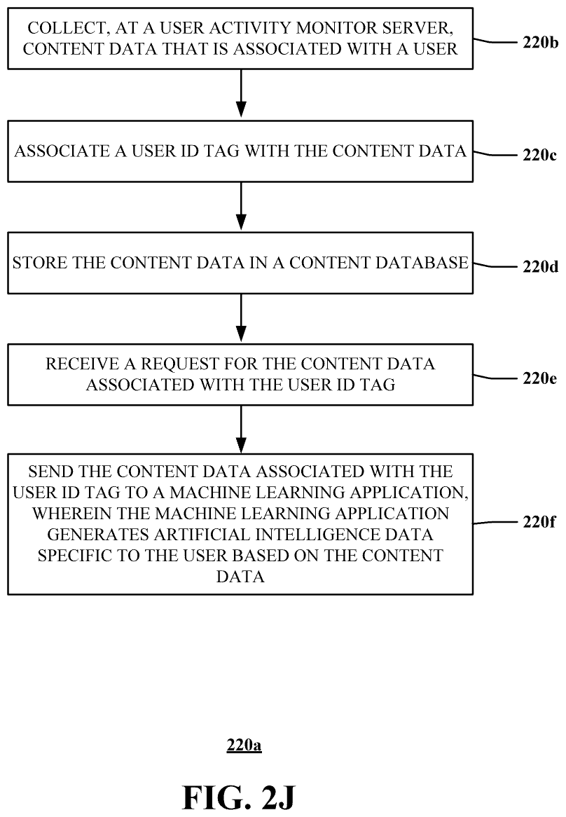

In many areas served by communication networks such as the communications network 125 of FIG. 1, there are available various sensors which collect and make available information about a location or an ambient environment. FIG. 2A is a block diagram illustrating an example, non-limiting embodiment of a sensor 200 functioning within the communications network 125 of FIG. 1 in accordance with various aspects described herein. The sensor 200 in the exemplary embodiment includes a sensor device 202a, a processor 202b, a memory 202e, and communication circuit 202c. The components of the sensor 200 may be powered by a battery 202d or other energy source. Components of the sensor 200 may be contained in a suitable housing which may, for example, provide weather resistance for outdoor applications. Other embodiments of sensor 200 may include other or additional elements for performing particular functions.

The sensor device 202a may be any device that collects information about an environment in which the sensor 200 is located. Examples of such a sensor device 202a include a camera which produces still images or video files or a video feed of a scene where the sensor 200 is located. The camera may include various types of cameras, such as image, video, infrared, thermal, and others and combinations of these. Another example of such a sensor device 202a is a microphone which is sensitive to audio in the vicinity of the sensor 200 and produces an analog signal or digital data representative of the sound.

Other examples of such sensor devices 200a measure or detect an ambient condition. One example of such a sensor device 202a is a pressure sensor which detects a pressure or force applied to the pressure sensor by another object or substance near the sensor 200 and produces an analog signal or digital data representative of the force. Another example of such a sensor device 202a is a touch sensor which detects a touch or contact, by a human or other, and produces an analog signal or digital data representative of the touch or contact. Another example of such a sensor device 202a is a light sensor that detects light or other ambient energy in the location of the sensor 200 and produces an analog signal or digital data representative of the light. Another example of such a sensor device 202a is a motion sensor which detects a motion applied to the sensor 200 and produces an analog signal or digital data representative of the motion. Another example of such a sensor device 202a is a temperature sensor which detects ambient temperature or another temperature in the vicinity of the sensor 200 and produces an analog signal or digital data representative of the temperatures. Any other type of sensor or combination of sensors may be included as the sensor device 202a.

The processor 202b may be part of a processing system which cooperates with data and instructions stored in the memory 202e to control operation of the sensor 200. The processor 202b may include one or more processors or microcontrollers or other data processing systems. The processor 202b may, for example, receive analog signals from the sensor device 202a and convert the analog signals to digital data. In other embodiments, the processor 202b may receive digital data from the sensor device 202a. The digital data may be stored in the memory 202e or provided to the communication circuit 202c. Further, the processor 202b may control functions of the sensor device 202a such as by turning on and off the sensor device 202a and modulating controllable aspects of the sensor device such as a relative sensitivity of a light sensor or touch sensor.

Further, the sensor device 202a may be associated with further control functions that may be managed by the processor 202b. In an example, the sensor device 202a includes a video camera mounted on a motor-controlled fixture that may be actuated to direct the video camera toward a selected direction. The processor 202b may receive signals from a remote source, via the communication circuit 202c, and in turn, generate control signals to actuate one or more motors and direct the camera to the selected direction. The processor 202b, or the sensor 200, may be location aware. For example, the processor 202b may receive location information from another source, such as a Global Positioning System (GPS) receiver of the communication circuit 202c, and determine location of the sensor 200 based on the location information.

The communication circuit 202c includes any suitable circuitry for communication of data and other information between the sensor 200 and a remote source or destination. In one example, the communication circuit 202c includes a cellular radio which may operate in conjunction with equipment of wireless access 120 (FIG. 1) to provide information related to the output of the sensor device 202a to a remote location over a cellular network such as a fifth generation (5G) cellular network, sixth generation (6G) cellular network or other radio network. The communication circuit 202c may also include short-range wireless communications capabilities not requiring a network, such as Wi-Fi® or Bluetooth®. Bluetooth® is a registered trademark owned by the Bluetooth Special Interest Group. Wi-Fi® is a registered trademark of the Wi-Fi Alliance. As noted, the communication circuit 202c may include a GPS or other circuit for receiving position-finding data for use in determining a location of the sensor 200. In another example, the communication circuit 202c may provide wireline communication such as over an Ethernet® connection to a remote source or destination. Ethernet is a registered trademark of Xerox Corporation.

The information communicated by the communication circuit 202c may include uplink information based on information sensed by or collected by the sensor device 202a, such as data forming a video feed from a video camera. The information communicated by the communication circuit 202c may include downlink information provided to the sensor 200 to control some aspect of the sensor 200, such as motor control signals to control a motor which directs the view of the video camera to a scene of interest or actuation signals to turn on or turn off the sensor device 202a or to control some feature of the sensor device 202a.

The battery 202d provides operating power to the components of the sensor 200. The battery 202d may be a depletable, rechargeable energy storage element. In embodiments, the battery 202 may be replaced by or may supplement a hard-wired connection to electrical mains.

Sensors such as the sensor 200 may be located in a variety of areas for collecting sensed information. The sensed information may be made available to remote destinations for use by various users. In some embodiments, sensors such as sensor 200 are used to implicitly generate content or explicitly generate content. These and other embodiments are further described below.

A problem exists in that there is not a means by which to capture a user's knowledge, as accumulated and demonstrated by their actions and activities, for the purpose of enabling an artificial intelligence-driven application to subsequently assist the user or another party in recalling this experientially demonstrated knowledge. This need may be particularly useful, for example, for a user who becomes forgetful, or whose memory is otherwise impaired, or for a virtual or real-life caregiver or assistant that can benefit from an understanding of the user's historical knowledge to assist the user, or for neurodivergent individuals who may have trouble focusing and recalling all facts for a particular scene or context. This solution uses content that users generate that may include content that they explicitly create, such as text, image, video or other media content, or content that they implicitly create, such as content that can be created that describes activity of the user based on sensors that observe the actions of the user. A user may be equipped with a device that has an onboard camera and microphone and other sensors. The device may be further equipped with one or more content generation apps and a user activity monitor app. The user device may communicate via these apps to a user activity monitor server. This server may also be in communication with a user-generated content server which has access to an accompanying user-generated content database. The user activity monitor server may also be in communication over a network with one or more external cameras and external microphones and other external sensors.

FIG. 2B is a block diagram illustrating an example, non-limiting embodiment of a user activity monitor server in communication with a user and external sensor in accordance with various aspects described herein. The components in FIG. 2B include a user device 204a, a content generation application 204d, a user activity monitor application 204e, a user activity monitor server 204h, a user-generated content server 204k, user-generated content 204l, an onboard camera 204b, an onboard microphone 204c, an external camera 204i, and an external microphone 204j. Explicitly generated content and user ID tag 204f, as well as implicitly generated content and user ID tag 204g, are also depicted.

The user device 204a is a versatile piece of technology that can be implemented as, for example, a cell phone or any variant thereof, such as a smartphone, tablet, or wearable device. This device is equipped with various sensors and applications that enable it to collect and generate content data associated with the user.

Various embodiments described herein collect implicitly generated content and explicitly generated content. As used herein, the term “implicitly generated content” generally refers to data that is automatically collected by monitoring a user's activities through sensors, such as cameras and microphones, without the user actively creating the content. For example, this can include audio recordings of conversations or images captured by a camera as the user goes about their daily activities. Further, as used herein, the term “explicitly generated content” generally refers to content that the user actively creates using various applications, such as writing an email, taking a photograph, or recording a video. An example difference between the two is that implicitly generated content is generally passively collected by observing the user's actions, while explicitly generated content is generally actively created by the user through deliberate actions.

In some embodiments, the user device 204a may include an onboard camera 204b and an onboard microphone 204c. The onboard camera 204b can capture images and videos of the user's surroundings, while the onboard microphone 204c can record audio, such as the user's conversations or ambient sounds. These sensors (and others) are integral to the device's ability to generate implicit content by monitoring the user's activities.

The user device 204a also runs several applications, commonly referred to as apps, that facilitate content generation and activity monitoring. For example, the Content Generation App 204d allows the user to explicitly create content in various media formats. This app could be an electronic mail app for composing and sending emails, a music creation app for producing audio tracks, a digital photography app for taking pictures, or a video recording app for capturing videos, or the like. These apps enable the user to generate content that is tagged with a user ID and sent to the User Activity Monitor Server 204h.

Additionally, the User Activity Monitor App 204e runs on the user device 204a to monitor the user's activities and implicitly generate content. This app collects data from the onboard sensors, such as the camera and microphone, to create a comprehensive record of what the user sees, says, hears, or does. For example, the User Activity Monitor App 204e might capture images of the user's environment through the onboard camera 204b and record audio through the onboard microphone 204c.

In some embodiments, the user device 204a may also communicate with external sensors, such as an external camera 204i and an external microphone 204j, to gather additional implicit content. These external sensors can be strategically placed in the user's environment to capture data that the onboard sensors might miss, providing a more complete picture of the user's activities.

The user device 204a, with its combination of onboard sensors and versatile apps, plays a role in the system's ability to collect and both explicitly and implicitly generate content data. This data is then processed by the User Activity Monitor Server 204h to create user-specific artificial intelligence that can assist the user or authorized third parties in recalling the user's historical knowledge and activities.

The User Activity Monitor Server 204h collects both explicitly generated content 204 f and implicitly generated content 204g, each tagged with a user ID. This server communicates with the User-Generated Content Server 204k, which stores the content data in a user-generated content database 204l. In some embodiments, the User Activity Monitor Server 204h is also in communication with external sensors, such as the external camera 204i and the external microphone 204j, to gather additional implicit content.

The interactions between these components enable the system to collect comprehensive data about the user's activities. In some embodiments, the User Activity Monitor Server 204h collects both explicitly generated content and implicitly generated content, tags it with the user ID, and stores it in the user-generated content database 204l. For example, the server might receive a video file created by the user and an audio recording captured by the onboard microphone, both tagged with the user ID. This data is then available for processing by a machine learning application to generate user-specific artificial intelligence data.

FIG. 2C is a block diagram illustrating an example, non-limiting embodiment of a system generating explicitly generated content in accordance with various aspects described herein. The components in FIG. 2C include the components shown in FIG. 2B, as well as content generation operation 206a and explicitly generated content record 206b.

In some embodiments, the user may use the user device to access the one or more content generation apps to generate content of various media types. This content, for example, may be text, video, image, or other media types, or mixed media types. For example, the content generation app may be an electronic mail app, a music creation app, an app for creating digital photographs or videos, or any other type of app that when used by the user, results in the generation by the user of content of one or more different types of media.

When the explicitly generated content is sent to the user generated content database, the content generation app may include a user ID tag that is assigned to the user so that when stored, the data includes a user ID tag, a content ID, and the content itself.

Content generation operation 206a represents operations of the user device when creating explicitly generated content. As described above, the user device 204a may be equipped with various sensors and applications that enable it to collect and generate content data associated with the user. In some embodiments, the user device 204a may include an onboard camera 204b and an onboard microphone 204c. The onboard camera 204b can capture images and videos of the user's surroundings, while the onboard microphone 204c can record audio, such as the user's conversations or ambient sounds.

Explicitly generated content record 206b represents the explicitly generated content record, which includes fields for the User ID Tag 206c, Content ID 206d, Content 206e, and Type 206f. The User ID Tag 206c is assigned to the user so that when the content is stored, it includes a unique identifier for the user. The Content ID 206d uniquely identifies the specific piece of content. The Content 206e field contains the actual content data, such as a file or media. The Type 206f field indicates that the content is explicitly generated.

In some embodiments, the Content Generation App 204d allows the user to create explicitly generated content in various media formats. For example, the user might create a video using a digital photography app, which is then tagged with the user ID and sent to the User Activity Monitor Server 204h. The User Activity Monitor Server 204h collects this explicitly generated content, tags it with the user ID, and stores it in the User-Generated Content Server 204k. The explicitly generated content record 206b ensures that each piece of content is properly identified and associated with the correct user.

FIG. 2D is a block diagram illustrating an example, non-limiting embodiment of system using a user activity monitor application in accordance with various aspects described herein.

The user may use a user interface to communicate with the user activity monitor app to set preferences as to what activity the user participates in, and what the user wishes to allow for monitoring and data collection to create content that describes activities by the user. This content includes implicitly generated content. In these embodiments, the implicitly generated content is not content that is explicitly created by the user. Rather, it is content that is sensed by either an onboard sensor, such as a camera or microphone, or an external sensor, such as a camera or microphone that collects data that describes activities of the user. In some embodiments, the user activities that are monitored may be the user's usage of other applications on the user device, such as content on the user device that is consumed by the user. The user's preferences as to what activities they want to opt in for monitoring may be saved in a user profiles database, which may save the settings as they relate to what types of sensor or other user monitoring, is allowed, as shown. The user may optionally specify what activities can be monitored, but also additionally layers on top of that a temporal specification for when the user's activities can be monitored with content being stored. For example, the user may specify that monitoring may exist for an upcoming period of time. In this case, the user activity monitor app and the content generation app control content that is sent to the user activity monitor server, and only permits it for the allowed duration of time. In another embodiment, the content generation app and the user activity monitor app may store implicitly and explicitly generated content locally, in the event that the user requests retroactive monitoring. For example, the user may not have monitoring activated, but they may realize that they want content to be sent after the fact. In this case, the user may submit a retroactive monitoring request, as shown. In such a case, the contents that were stored locally for the retroactive period of time is then released and sent to the user activity monitor server.

In other embodiments, the User Activity Monitor App 204e is a system level application. In this operating mode, actions that the user spends in other applications or on other content sources may be collected. Without a system operating mode, the User Activity Monitor App 204e may still monitor actions of other applications but they may require explicit approval. Different from explicitly identified content sources above (e.g. specific audio, visual, or tactile content), signals may indicate time on a website, time in a social media application, or the number of transactions executed on a financial trading application. In each instance, no specific user generated content is created but the activity of the user may be recorded as an activity. Adopting prior definitions, this implicit information may be enabled or disabled with explicit rules, timing guidelines (e.g. only during work hours), or through other contextual cues (only in certain locations or in the proximity of other users). In yet another similar embodiment, the monitoring of the User Activity Monitor App 204e may solicit implicit activity history from other connected sensors or services that the user is known to interact with. For example, the application may request all transactions of a specific nature (e.g. financial) associated with the user from other devices (e.g. automated tap-to-pay, e-commerce, or gambling applications).

The User Activity Monitor App 204e is an application that runs on the user device and allows the user to set preferences for monitoring their activities. In some embodiments, the User Activity Monitor App 204e may provide options for the user to specify what activities can be monitored, such as what they see, say, hear, or do. For example, the user may use the app to allow access to monitor their activities until they get home or for the next hour. Further, in some embodiments, the User Activity Monitor App 204e may be implemented as a mobile application on a smartphone or tablet.

User Profiles 208b is a database that stores the user's preferences for monitoring activities. This database includes fields such as the User ID Tag field 208c, which uniquely identifies the user, and fields for Camera Use Access 208d, Device Use Access 208e, and Microphone Use Access 208f, which store the user's preferences for allowing access to the respective sensors. For example, the Camera Use Access field 208d may indicate whether the user has allowed the use of the camera for monitoring activities.

FIG. 2E is a block diagram illustrating an example, non-limiting embodiment of a system generating implicitly generated content in accordance with various aspects described herein.

When the user permits the user device's onboard sensors to monitor the user's activities and record them for use, this access permission, as noted, is stored in the user profile database. Subsequently, the user activity monitor app may monitor the user device's collection of data from the sensors and create user-generated content database entries that include any type of media or mixed media files. For example, content that the user views on their device may be stored, audio content that is collected by the onboard microphone that represents spoken words by the user may be stored, images of the user or videos of the user recorded using their onboard camera may be stored, and others. In a like manner, when the user provides permission for the monitoring of their activities, the user may also elect to enable external sensors as well, such as cameras and microphones, to monitor the user's activities. In this case, the external sensors may be registered in a separate database with their location being known. This location and range of operation may be compared with the location of the user device to identify sensors that are in range to be able to collect data that describes the user's activity at any point in time. Therefore, as before, if external sensors are enabled, they may collect data describing the activities of the user within the location and send them, along with a user ID tag, to the user-generated content database.

Content generation operation 210a represents the content generation process when creating implicitly generated content, which involves collecting and tagging content data with the user ID before storing it in the implicitly generated content record 210b within User-Generated Content 204l.

Implicitly generated content record 210b represents the implicitly generated content record, which includes data collected by monitoring the user's activities through sensors. In some embodiments, this data is automatically collected without the user actively creating it. For example, the onboard camera and microphone on the user device may capture images, videos, and audio recordings of the user's surroundings and activities. The implicitly generated content is tagged with the user ID and stored in the User-Generated Content 204l.

In some embodiments, the user activity monitor app on the user device collects data from the onboard sensors and sends it to the user activity monitor server. The user's preferences stored in the user profiles database determine what types of content are collected and when monitoring is permitted. For example, if the user has allowed camera use access, the system may collect images or videos captured by the onboard camera during the specified monitoring period. The interactions between these components enable the system to collect comprehensive data about the user's activities, ensuring that both explicitly and implicitly generated content is properly tagged and stored for future use in generating user-specific artificial intelligence.

FIG. 2F is a block diagram illustrating an example, non-limiting embodiment of a system collecting content data for use in machine learning in accordance with various aspects described herein. As shown in FIG. 2F, a data collector may exist within the user activity monitor server that collects the user generated content, whether it is implicitly or explicitly generated. Since each content record has a user identification tag, the data collector may collect only content data for a specific user. The data collector therefore may send a feed of data containing implicitly and explicitly generated user content that describes the user's activities over a period of time.

The Data Collector 212a is responsible for aggregating both explicitly and implicitly generated content associated with a user. It identifies and collects content data based on user ID tags associated with each content record, ensuring that only relevant data for a specific user is processed. The Data Collector 212a gathers content from various sources, including the User-Generated Content Server 204k and external sensors, such as video files, audio recordings, and other media types tagged with the user ID. This collected data is then sent to a machine learning application for further processing. By efficiently managing and organizing user-specific content, the Data Collector 212a enables the system to generate personalized artificial intelligence data, which can be utilized for applications like personal recall or caregiving.

FIG. 2G is a block diagram illustrating an example, non-limiting embodiment of a system generating personal AI data in accordance with various aspects described herein. The Personal AI Application 214a processes the collected content data to generate user-specific artificial intelligence. Personal AI application 214a includes Machine Learning Algorithm 214b, and AI 214c, and is provided Explicitly Generated Content plus User ID Tag 214d and Implicitly Generated Content plus User ID Tag 214e by data collector 212a. Explicitly Generated Content plus User ID Tag 214d represents the explicitly generated content created by the user, such as text, images, and videos, tagged with the user ID. Implicitly Generated Content plus User ID Tag 214e represents the implicitly generated content collected by monitoring the user's activities through sensors, also tagged with the user ID.

The Machine Learning Algorithm 214b processes both explicitly and implicitly generated content to generate artificial intelligence data specific to the user. This AI data, represented by AI 214c, encapsulates the user's knowledge, experiences, capabilities, and expertise. The AI data is then stored in the user profile database and can be accessed through various applications, such as personal recall or caregiving applications.

The resulting user-specific artificial intelligence data may be stored for each user in the user profile database. This then makes personal artificial intelligence available for other applications to subsequently use as permitted by the user.

The machine learning algorithms utilized in the system can vary widely depending on the specific requirements and the nature of the data being processed. Commonly used algorithms include supervised learning algorithms, such as decision trees, support vector machines (SVM), and neural networks, as well as unsupervised learning algorithms, such as clustering and dimensionality reduction techniques. For example, a neural network might be implemented to recognize patterns in the user's activities and generate personalized AI data that reflects the user's knowledge and experiences. In some embodiments, the machine learning algorithm 214b processes both explicitly and implicitly generated content to generate artificial intelligence data specific to the user. This AI data, represented by AI 214c, encapsulates the user's knowledge, experiences, capabilities, and expertise. The implementation of these algorithms may involve training the models on large datasets of user-generated content, fine-tuning the models to improve accuracy, and continuously updating the models as new data is collected. The machine learning application 214a, which includes the machine learning algorithm 214b, plays a useful role in transforming raw content data into meaningful AI insights that can be used for various applications, such as personal recall or caregiving.

FIG. 2H is a block diagram illustrating an example, non-limiting embodiment of a user performing a query of personal AI data using a personal recall application in accordance with various aspects described herein.

To make use of the personal AI data, the user themselves may use an app, such as a personal recall application 216a on their device to submit a query that involves accessing their personal AI data. For example, the user may ask about how they performed a task in the past, which may have been captured as implicitly or explicitly generated content data. The personal AI data may be used then to create or supplement the response to the user. This type of recall application initiated by the user themselves may also apply to other types of implicitly or explicitly generated content, such as collective knowledge accumulated by the user in their activities: what they read, what they see, what they do, etc.

In some embodiments, the User Device 204a is equipped with a Personal Recall App 216a, which allows the user to submit queries to access their personal AI data. For example, the user might ask, “How did I bake this cake before?” as shown by Query 216b. This query is processed by the Personal Recall App 216a, which communicates with the User Activity Monitor Server 204h to retrieve the relevant personal AI data.

In some embodiments, the Personal Recall App 216a on the User Device 204a allows the user to submit queries that involve accessing their personal AI data. For example, the user might ask about how they performed a task in the past, which may have been captured as implicitly or explicitly generated content data. The personal AI data is then used to create or supplement the response to the user. This type of recall application can also apply to other types of implicitly or explicitly generated content, such as collective knowledge accumulated by the user in their activities: what they read, what they see, what they do, etc.

In another embodiment, the Personal Recall App 216a on the User Device 204a may utilize Generative AI to interpolate recall moments for the user. In this interpolated mode, the explicit facts and events that were used to train the model in 214c are retained but a base-level model (e.g. generalized from open source material, trained in aggregate across the service's user base, or from other proximal users like relatives of the primary user) may be used to interpolate missing areas of information. For example, the query 216b may map to an explicit instance in the user-generated content database (whether implicitly or explicitly generated content). However, it may also map to previous instances of the activity that are learned from across other historical users. This interpolated knowledge may help to fill in gaps from the user's specific experience (e.g., the user baked a cake but missed some of the core steps) or it may interpolate from entirely different experiences (e.g., the user's family typically bakes a cake with an entirely different ingredient). Some examples of the presentation of these interpolated results include the following: both an actual response and an interpolated response are provided, an actual response is provided by with a link to an interpolated answer, an interpolated answer is provided as an illustration or alternate answer, or the system evaluates the quality (as determined by fidelity of the content or a user-specific preference) of both the actual and interpolated answer and chooses the best answer to present to the user within the Personal Recall App 216a.

The interactions between these components enable the system to provide personalized responses to user queries based on their historical activities. The Personal Recall App 216a plays a useful role in allowing the user to access and utilize their personal AI data, enhancing their ability to recall past experiences and knowledge.

FIG. 2I is a block diagram illustrating an example, non-limiting embodiment of a third party performing a query of personal AI data using a personal recall application in accordance with various aspects described herein. The components shown in FIG. 2I include a Personal Recall App 218a, a User Device 218b, a Third Party user 218c, and a Query 218d.

In another example, the user may specify in the user profile database one or more third-party users that have access to the user's personal AI data. The third-party user 218c may use a personal recall app running on the third party user's device 218b in order to better inform the third-party user about the user's historical activities, as defined by the user's explicitly and implicitly generated content that generated the personal AI for the user. This may permit the third-party user to better perform services for the user, such as customer service, caregiving, or other services.

In some embodiments, the Personal Recall App 218a is an application running on the User Device 218b, which is operated by the Third Party user 218c. This app allows the third party user to submit queries to access the user's personal AI data. For example, the third party user might ask, “What would be a good lunch menu for Roger?” as shown by Query 218d. This query is processed by the Personal Recall App 218a, which communicates with the User Activity Monitor Server to retrieve the relevant personal AI data.

In some embodiments, the Personal Recall App 218a on the User Device 218b allows the third party to submit queries that involve accessing the user's personal AI data. For example, the third party might ask about the user's preferences or past activities, which may have been captured as implicitly or explicitly generated content data. The personal AI data is then used to create or supplement the response to the third party. This type of recall application can also apply to other types of implicitly or explicitly generated content, such as collective knowledge accumulated by the user in their activities: what they read, what they see, what they do, etc.

The interactions between these components enable the system to provide personalized responses to third-party queries based on the user's historical activities. The Personal Recall App 218a plays a useful role in allowing the third party user to access and utilize the user's personal AI data, enhancing their ability to provide informed assistance or services based on the user's past experiences and knowledge.

FIG. 2J depicts an illustrative embodiment of a method in accordance with various aspects described herein. At block 220b, the method 220a involves collecting, at a user activity monitor server, content data that is associated with a user. This content data includes both explicitly generated content, which the user creates, and implicitly generated content, which is gathered by monitoring the user's activities through sensors. In some embodiments, block 220b involves collecting data from various sources, such as onboard sensors on the user's device and external sensors. For example, the onboard camera and microphone on the user's device may capture images, videos, and audio recordings of the user's surroundings and activities.

At block 220c, the method involves associating a user ID tag with the content data. This ensures that all collected content data is properly tagged and associated with the correct user. In some embodiments, block 220c involves tagging each piece of content with a unique user identifier, which helps in organizing and retrieving the data later. For example, the user ID tag may be assigned to video files, audio recordings, and other media types collected from the user.

At block 220d, the method involves storing the content data in a content database. This ensures that the collected and tagged content data is securely stored for future use. In some embodiments, block 220d involves storing the data in a user-generated content database, which can be accessed by the user activity monitor server. For example, the content database may store text, images, videos, and other media types generated by the user.

At block 220e, the method involves receiving a request for the content data associated with the user ID tag. This allows the system to retrieve the relevant content data based on the user's request. In some embodiments, block 220e involves receiving requests from various applications, such as a personal recall application or a third-party application. For example, the user may request to access their past activities or a third party may request information to assist the user.

At block 220f, the method involves sending the content data associated with the user ID tag to a machine learning application, wherein the machine learning application generates artificial intelligence data specific to the user based on the content data. This involves processing the collected content data to create personalized AI that represents the user's knowledge, experiences, capabilities, and expertise. In some embodiments, block 220f involves using machine learning algorithms to analyze the content data and generate user-specific AI. For example, the machine learning application may use neural networks, decision trees, or support vector machines to process the data and create meaningful AI insights.

The method depicted in FIG. 2J provides comprehensive support for all claims by detailing the process of collecting, tagging, storing, retrieving, and processing user-generated content to create personalized artificial intelligence. This method enables the system to assist users and authorized third parties in recalling the user's historical knowledge and activities, enhancing their ability to provide informed assistance or services.

While for purposes of simplicity of explanation, the respective processes are shown and described as a series of blocks in FIG. 2J, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

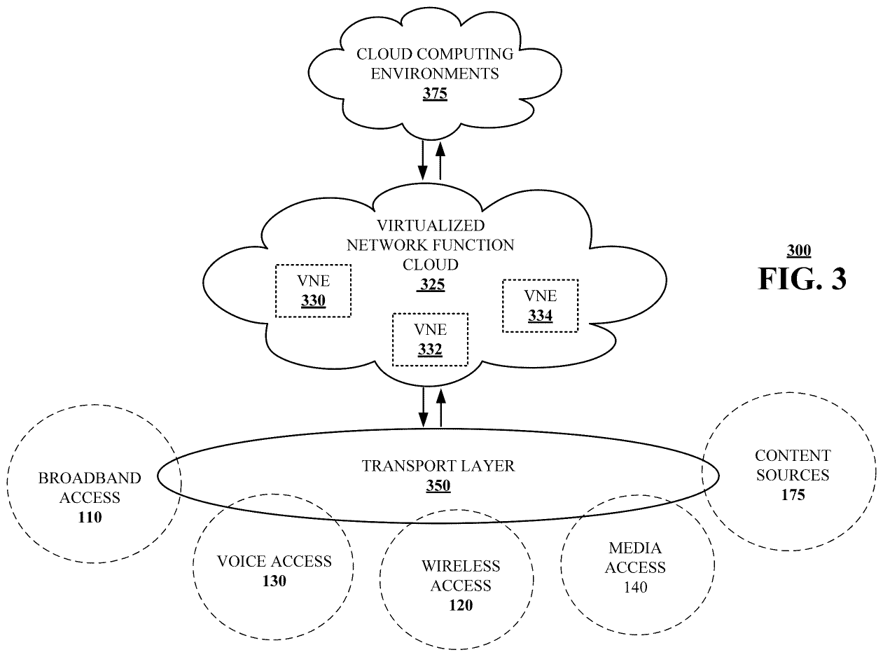

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part network-based collection of user activity data for personal artificial intelligence.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

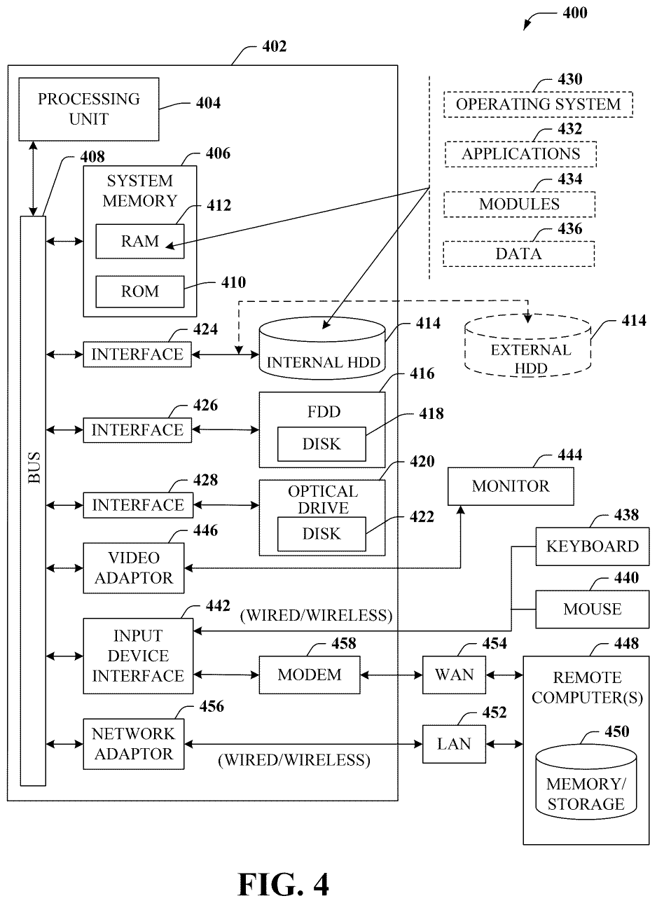

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part network-based collection of user activity data for personal artificial intelligence.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

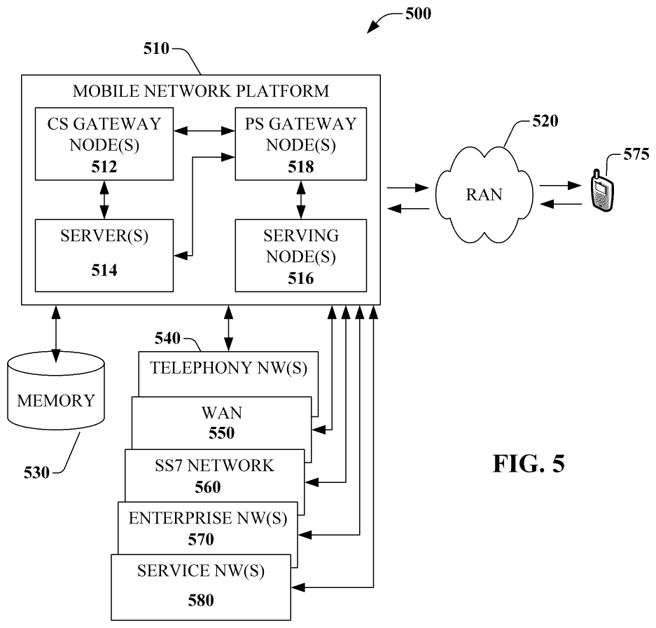

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in network-based collection of user activity data for personal artificial intelligence. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

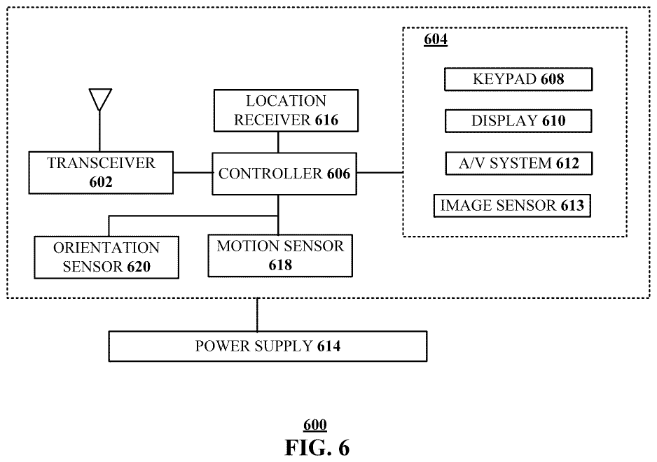

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part network-based collection of user activity data for personal artificial intelligence.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
collecting, at a user activity monitor server, content data that is associated with a user, wherein the content data includes explicitly generated content generated by the user and implicitly generated content generated by monitoring activities of the user through sensors;
associating, at the user activity monitor server, a user ID tag with the content data;
storing the content data in a content database;
receiving, at the user activity monitor server, a request for the content data associated with the user ID tag;
retrieving, by the user activity monitor server, the content data associated with the user ID tag; and
sending the content data associated with the user ID tag to a machine learning application, wherein the machine learning application generates artificial intelligence data specific to the user based on the content data.

2. The device of claim 1, wherein the operations further comprise:
receiving a request from a personal recall application for use of the artificial intelligence data specific to the user.

3. The device of claim 2, wherein the receiving the request from the personal recall application comprises receiving a request from a personal recall application controlled by the user.

4. The device of claim 2, wherein the receiving the request from the personal recall application comprises receiving a request from a personal recall application controlled by a third party.

5. The device of claim 1, wherein the operations further comprise:
providing access to the artificial intelligence data through a personal recall application, wherein the personal recall application allows the user or an authorized third party to query and utilize the artificial intelligence data.

6. The device of claim 1, wherein the implicitly generated content is generated by monitoring a user's activities through sensors on-board a device of the user.

7. The device of claim 6, wherein the sensors on-board the device of the user include a camera and a microphone.

8. The device of claim 1, wherein the implicitly generated content is generated by monitoring a user's activities through sensors external to a device of the user.

9. The device of claim 1, wherein the explicitly generated content is created by a user through one or more content generation applications.

10. The device of claim 1, wherein the operations further comprise receiving user preferences for monitoring activities, and storing these preferences in a user profiles database.

11. The device of claim 10, wherein the user preferences include temporal settings specifying when the activities of the user can be monitored.

12. A non-transitory machine-readable medium, comprising executable instructions that, when executed by a processing system including a processor, facilitate performance of operations, the operations comprising:
collecting content data that is associated with a user;
associating a user ID tag with the content data;
storing the content data in a content database;
receiving a request for the content data associated with the user ID tag;
retrieving the content data associated with the user ID tag; and
sending the content data associated with the user ID tag to a machine learning application, wherein the machine learning application generates artificial intelligence data specific to the user based on the content data.

13. The non-transitory machine-readable medium of claim 12, wherein the collecting the content data associated with the user comprises collecting content data that has been explicitly generated by the user.

14. The non-transitory machine-readable medium of claim 12, wherein the collecting the content data associated with the user comprises collecting content data that has been implicitly generated through sensors.

15. The non-transitory machine-readable medium of claim 14, wherein the operations further comprise receiving user preferences for monitoring activities used to generate the content data, and storing these preferences in a user profiles database.

16. The non-transitory machine-readable medium of claim 12, wherein the operations further comprise providing access to the artificial intelligence data through a personal recall application, wherein the personal recall application allows the user or an authorized third party to query and utilize the artificial intelligence data.

17. A method, comprising:
collecting, by a processing system including a processor, content data that is associated with a user, wherein the content data includes implicitly generated content generated by monitoring activities of the user through sensors;
associating, by the processing system, a user ID tag with the content data;
storing, by the processing system, the content data in a content database;
receiving, by the processing system, a request for the content data associated with the user ID tag;
retrieving, by the processing system, the content data associated with the user ID tag; and
sending, by the processing system, the content data associated with the user ID tag to a machine learning application, wherein the machine learning application generates artificial intelligence data specific to the user based on the content data

18. The method of claim 17, further comprising:
receiving, by the processing system, a request from a personal recall application for use of the artificial intelligence data specific to the user.

19. The method of claim 18, further comprising:
providing the artificial intelligence data specific to the user to the personal recall application to enable the personal recall application to provide interpolated results.

20. The method of claim 18, wherein the receiving the request from the personal recall application comprises receiving a request from a personal recall application controlled by a third party.
